(19) United States
(12) Patent Application Publication
(10) Pub. No.: US 2010/0136078 A1
(43) Pub. Date: Jun. 3, 2010

(54) INSECTICIDAL COMPOSITION AND ARTICLE OBTAINED THEREOF

(76) Inventors: Pierre Herben, Ixelles (BE); Gabriella Sartori, Ferrara (IT); Fabio Di Pietro, Ferrara (IT)

Correspondence Address: BASELL USA INC., NEWTOWN SQUARE CENTER, 3801 WEST CHESTER PIKE, BLDG. B, NEWTOWN SQUARE, PA, 19073, US

(21) Appl. No.: 12/451,588

(22) PCT Filed: May 5, 2008
(86) PCT No.: PCT/EP2008/055499

§ 371 Date: Nov. 20, 2009

Related U.S. Application Data
(60) Provisional application No. 60/932,566, filed on May 31, 2007.

(30) Foreign Application Priority Data
May 23, 2007 (EP) 07108778.7

(51) Int. Cl. A01N 65/12; A01N 25/34; A01P 7/02; A01P 7/04

(52) U.S. Cl. 424/409; 514/65

(57) ABSTRACT

A material having insecticidal and acaricidal properties comprising: A) From 99.95 by weight to 70.0% by weight a propylene based polymer obtainable by using a catalyst system comprising a metallocene compound having the following properties: i) a Melt Flow Rate (MFR) (ISO 1133) comprised between 2 and 100; ii) A distribution of molecular weight Mw/Mn lower than 4; iii) Isotactic pentads (mmmm) comprised between 90% and 99%; B) From 0.05% to 30% by weight of an adduct of formula T¹-T² resulting from the condensation of T¹ and T², wherein T¹ comprises at least one pyrethroid substance, which is substantially stable up to a temperature of at least 150° C.; T² is an ethylenically unsaturated substance chooses from the group consisting of: (a) a surfactants, (b) vinyl phospates and (c) mixtures thereof.

The present invention relates to a material having insecticidal and acaricidal properties comprising a pyrethroid substance and a propylene polymer.

WO2004/089086 relates to a composition comprising a pyrcthroid substance and a compound having an ethylenically unsaturated group. The composition described in that patent application can be used as an additive for a polymeric composition in order to obtain a final material able to release an insecticidal flux. This material is useful for the production of various articles such as fibers and mosquito-nets. But can bee used as well for other extruded items as films, Thermoformed or Injection moulded items.

Propylene polymer is a versatile thermoplastic material compatible with many process techniques, it has a moderate costs and favorable properties for many applications.

Thus it represent a valid alternative for the production of the material described in WO2004/089086.

Among other polymeric materials WO2004/089086 cites in a generic way that polypropylene can be used. No examples of the use of this material with the composition taught in WO 2004/089086 are present. A general isotactic polypropylene is used only in a comparative example. In this example the polypropylene polymer is not characterized. Propylene polymers represent an economic alternative for the production of the material described in WO2004/089086. The applicant found that there is a particular class of propylene polymers having specific features able to give better results in terms of insecticidal flow.

The applicant has found that, when a particular propylene polymer obtained by using metallocene-based catalyst systems and having particular features is used, it is possible to improve the characteristics of this insecticidal material.

An object of the present invention is thus a material having insecticidal and acaricidal properties comprising:
A) From 70.0 to 99.9% by weight of a propylene-based polymer obtainable by using a catalyst system comprising a metallocene compound, such polymer having the following properties:
i) a Melt Flow Rate (MFR) (ISO 1133) comprised between 2 and 100; preferably between 6 and 60, more preferably between 15 and 35;
ii) A distribution of molecular weight Mw/Mn lower than 4; preferably lower than 3;
iii) Isotactic pentads (mmmm) comprised between 90% and 99%; preferably between 91% and 95% more preferably between 92% and 94%;
B) From 0.1 to 30% by weight of an adduct of formula T¹-T² resulting from the condensation of T¹ and T², wherein
T¹ comprises at least one pyrethroid substance, which is substantially stable up to a temperature of at least 150° C.; preferably substantially stable up to temperature of at least 300° C.;
T² is an ethylenically unsaturated substance chosen from the group consisting of:
   (a) surfactants,
   (b) vinyl phosphates and
   (c) mixtures thereof.

Preferably from 80 and 99.95% by weight of (A) and from 0.05% and 20% by weight of B is used; more preferably from 85 to 99.5% by weigh of A and from 0.5 to 15% by weight of B is used, even more preferably from 95 to 99% by weight of A and from 1 to 5% by weight of B is used.

The propylene-based polymer (A) can be a propylene homopolymer, a propylene copolymer or a mixture thereof. The propylene copolymer contains from 0.1 to 50% by mol of derived units of ethylene or an alpha-olefin of formula CH₂═CHZ wherein Z is a linear or branched C₂-C₂₀ radical; preferably said propylene copolymer contains from 1 to 15% by mol of ethylene or said alpha-olefin; preferred comonomers are ethylene and 1-butene.

The propylene based polymer (A) is obtainable by using a catalyst system comprising a metallocene compound, this allow to the polymer to be endowed with particular homogeneity properties due to the particular class of catalysts used.

The propylene based polymer (A) is obtainable by polymerizing propylene and optionally an alpha-olefin of formula CH₂═CHZ in polymerization conditions in the presence of a catalyst system obtainable by contacting:
(a) a stereorigid metallocene compound;
   (b) an alumoxane or a compound capable of forming an alkyl metallocene cation;

In particular the propylene based polymer of the present invention useful for the process of the present invention' is obtainable by using a catalyst system obtainable by contacting:

a) a metallocene compound of formula (I)

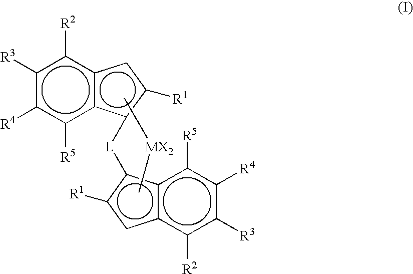

wherein
M is a transition metal belonging to group 3, 4, 5, 6 or to the lanthanide or actinide groups in the Periodic Table of the Elements; preferably M is titanium, zirconium or hafnium;
X, same or different, is a hydrogen atom, a halogen atom, or a R, OR, OSO₂CF₃, SR, NR₂ or PR₂ group, wherein R is a are linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylallyl radicals; optionally containing heteroatoms belonging to groups 13-17 of the Periodic Table of the Elements; preferably R is a linear or branched C₁-C₂₀-alkyl radical; or two X can optionally form a substituted or unsubstituted butadienyl radical or a OR′O group wherein R′ is a divalent radical selected from C₁-C₄₀ alkylidene, C₆-C₄₀ arylidene, C₇-C₄₀ alkylarylidene and C₇-C₄₀ arylalkylidene radicals; preferably X is a hydrogen atom, a halogen atom or a R group; more preferably X is chlorine or a C₁-C₁₀-alkyl radical; such as methyl, or ethyl radicals;
L is a divalent C₁-C₄₀ hydrocarbon radical optionally containing heteroatoms belonging to groups 13-17 of the Periodic Table of the Elements or a divalent silylidene radical containing up to 5 silicon atom; preferably L is a divalent bridging group selected from C₁-C₄₀ alkylidene, C₃-C₄₀ cycloalkylidene, C₆-C₄₀ arylidene, C₇-C₄₀ alkylarylidene, or C₇-C₄₀ arylalkylidene radicals optionally containing heteroatoms belonging to groups 13-17 of the Periodic Table of the Elements, and silyliene radical containing up to 5 silicon atoms such as SiMe₂, SiPh₂; preferably L is a group (Z(R″)₂)ₙ wherein Z is a carbon or a silicon atom, n is 1 or 2 and R″ is a C₁-C₂₀ hydrocarbon radical optionally containing heteroatoms belonging to groups 13-17 of the Periodic Table of the Elements; preferably R″ is a linear or branched, cyclic or acyclic, C₁-C₂₀-alkyl, C₂-C₂₀ alkenyl, C₂-C₂₀ alkynyl, C₆-C₂₀-aryl, C₇-C₂₀-alkylaryl or C₇-C₂₀-arylalkyl radicals optionally containing heteroatoms belonging to groups 13-17 of the Periodic Table of the Elements; more preferably the group (Z(R″)₂)ₙ is Si(CH₃)₂, SiPh₂, SiPhMe, SiMe(SiMe₃), CH₂, (CH₂)₂, and C(CH₃)₂; even more preferably (Z(R″)₂)ₙ is Si(CH₃)₂.
R¹ is a C₁-C₄₀ hydrocarbon radical optionally containing heteroatoms belonging to groups 13-17 of the Periodic Table of the Elements; preferably R′ is linear or branched, cyclic or acyclic, C₁-C₄₀-alkyl, C₂-C₄₀ alkenyl, C₂-C₄₀ alkynyl, C₇-C₄₀-alkylaryl or C₇-C₄₀-arylalkyl radical; optionally containing heteroatoms belonging to groups 13-17 of the Periodic Table of the Elements; more preferably R′ is a linear or branched, saturated or unsaturated C₁-C₂₀-alkyl radical;
R², R³, R⁴ and R⁵, equal to or different from each other, are hydrogen atoms or C₁-C₄₀ hydrocarbon radicals optionally containing heteroatoms belonging to groups 13-17 of the Periodic Table of the Elements or two R groups can be joined to form a 5 to 7 membered saturated or unsaturated ring; preferably R², R³, R⁴ and R⁵, equal to or different from each other are hydrogen atoms or linear or branched, cyclic or acyclic, C₁-C₁₀-alkyl, C₂-C₄₀ alkenyl, C₂-C₄₀ alkynyl, C₆-C₄₀-aryl, C₇-C₄₀-alkylaryl or C₇-C₄₀-arylalkyl radical; optionally containing heteroatoms belonging to groups 13-17 of the Periodic Table of the Elements; or two R groups can be joined to form a 5 to 7 membered saturated or unsaturated ring;
   (b) an alumoxane or a compound capable of forming an alkyl metallocene cation;

Alumoxanes used as component b) can be obtained by reacting water with an organo-aluminium compound of formula HⱼAlU₃₁ or HⱼAl₂U₆₋ⱼ, where U substituents, same or different, are hydrogen atoms, halogen atoms, C₁-C₂₀-alkyl, C₃-C₂₀-cyclalkyl, C₆-C₂₀-aryl, C₇-C₂₀-alkylaryl or or C₇-C₂₀-arylalkyl radical, optionally containing silicon or germanium atoms with the proviso that at least one U is different from halogen, and j ranges from 0 to 1, being also a non-integer number. In this reaction the molar ratio of Al/water is preferably comprised between 1:1 and 100:1. The molar ratio between aluminium and the metal of the metallocene generally is comprised between about 10:1 and about 20000:1, and more preferably between about 100:1 and about 5000:1. The alumoxanes used in the catalyst according to the invention are considered to be linear, branched or cyclic compounds containing at least one group of the type:

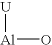

wherein the substituents U, same or different, are described above.

In particular, alumoxanes of the formula:

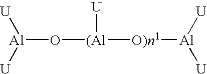

can be used in the case of linear compounds, wherein n′ is 0 or an integer from 1 to 40 and the substituents U are defined as above, or alumoxanes of the formula:

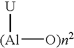

can be used in the case of cyclic compounds, wherein n² is an integer from 2 to 40 and the U substituents are defined as above. Examples of alumoxanes suitable for use according to the present invention are methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO) and tetra-(2,3,3-trimethylbutyl)alumoxane (TTMBAO). Particularly interesting cocatalysts are those described in WO 99/21899 and in WO01/21674 in which the alkyl and aryl groups have specific branched patterns. Non-limiting examples of aluminium compounds according to WO 99/21899 and WO01/21674 are:
tris(2,3,3-trimethyl-butyl)aluminium, tris(2,3-dimethyl-hexyl)aluminium, tris(2,3-dimethyl-butyl)aluminium, tris(2,3-dimethyl-pentyl)aluminium, tris(2,3-dimethyl-heptyl)aluminium, tris(2-methyl-3-ethyl-pentyl)aluminium, tris(2-methyl-3-ethyl-hexyl)aluminium, tris(2-methyl-3-ethyl-heptyl)aluminium, tris(2-methyl-3-propyl-hexyl)aluminium, tris(2-ethyl-3-methyl-butyl)aluminium, tris(2-ethyl-3-methyl-pentyl)aluminium, tris(2,3-diethyl-pentyl)aluminium, tris(2-propyl-3-methyl-butyl)aluminium, tris(2-isopropyl-3-methyl-butyl)aluminium, tris(2-isobutyl-3-methyl-pentyl)aluminium, tris(2,3,3-trimethyl-pentyl)aluminium, tris(2,3,3-trimethyl-hexyl)aluminium, tris(2-ethyl-3,3-dimethyl-butyl)aluminium, tris(2-ethyl-3,3-dimethyl-pentyl)aluminium, tris(2-isopropyl-3,3-dimethyl-butyl)aluminium, tris(2-trimethylsilyl-propyl)aluminium, tris(2-methyl-3-phenyl-butyl)aluminium, tris(2-ethyl-3-phenyl-butyl)aluminium, tris(2,3-dimethyl-3-phenyl-butyl)aluminium, tris(2-phenyl-propyl)aluminium, tris[2-(4-fluoro-phenyl)-propyl]aluminium, tris[2-(4-chloro-phenyl)-propyl]aluminium, tris[2-(3-isopropyl-phenyl)-propyl]aluminium, tris(2-phenyl-butyl)aluminium, tris(3-methyl-2-phenyl-butyl)aluminium, tris(2-phenyl-pentyl)aluminium, tris[2-(pentafluorophenyl)-propyl]aluminium, tris[2,2-diphenyl-ethyl]aluminium and tris[2-phenyl-2-methyl-propyl]aluminium, as well as the corresponding compounds wherein one of the hydrocarbyl groups is replaced with a hydrogen atom, and those wherein one or two of the hydrocarbyl groups are replaced with an isobutyl group.

Amongst the above aluminium compounds, trimethylaluminium (TMA), triisobutylaluminium (TIBAL), tris(2,4,4-trimethyl-pcntyl)aluminium (TIOA), tris(2,3-dimethylbutypaluminium (TDMBA) and tris(2,3,3-trimethylbutyl)aluminium (TTMBA) are preferred.

Non-limiting examples of compounds able to form an alkylmetallocene cation are compounds of formula D⁺E⁻, wherein D⁺ is a Brønsted acid, able to donate a proton and to react irreversibly with a substituent X of the metallocene of formula (I) and E⁻ is a compatible anion, which is able to stabilize the active catalytic species originating from the reaction of the two compounds, and which is sufficiently labile to be able to be removed by an olefinic monomer. Preferably, the anion E⁻ comprises of one or more boron atoms. More preferably, the anion E⁻ is an anion of the formula BAr₄⁽⁻⁾, wherein the substituents Ar which can be identical or different are aryl radicals such as phenyl, pentafluorophenyl or bis(trifluoromethyl)phenyl. Tetrakis-pentafluorophenyl borate is particularly preferred examples of these compounds are described in WO 91/02012. Moreover, compounds of the formula BAr₃ can conveniently be used. Compounds of this type are described, for example, in the published International patent application WO 92/00333. Other examples of compounds able to form an alkylmetallocene cation are compounds of formula BAr₃P wherein P is a substituted or unsubstituted pyrrol radicals. These compounds are described in WO01/62764. Other examples of cocatalyst can be found in EP 775707 and DE 19917985. Compounds containing boron atoms can be conveniently supported according to the description of DE-A-19962814 and DE-A-19962910. All these compounds containing boron atoms can be used in a molar ratio between boron and the metal of the metallocene comprised between about 1:1 and about 10:1; preferably 1:1 and 2.1; more preferably about 1:1.

Non limiting examples of compounds of formula D⁺E⁻ are:
Triethylammoniumtetra(phenypborate,
Trimethylammoniumtetra(tolyl)borate,
Tributylammoniumtetra(tolyl)borate,
Tributylammoniumtetra(pentafluorophenyl)borate,
Tripropylammoniumtetra(dimethylphenyl)borate,
Tributylammoniumtetra(trifluoromethylphenyl)borate,
Tributylammoniumtetra(4-fluorophenyl)borate,
N,N-Dimethylaniliniumtetra(phenyl)borate,
N,N-Dimethylaniliniumtetrakis(pentafluorophenyl)boratee,
Di(propyl)ammoniumtetrakis(pentafluorophenyl)borate,
Di(cyclohcxypammoniumtetrakis(pentafluorophenyl)borate,
Triphenylphosphoniumtetrakis(phenyl)borate,
Tri(methylphenyl)phosphoniumtetrakis(phenyl)borate,
Tri(dimethylphenyl)phosphoniumtetrakis(phenyl)borate,
Triphenylcarbeniumtetrakis(pentafluorophenyl)borate,
Triphenylcarbeniumtetrakis(phenyl)aluminate,
Ferroceniumtetrakis(pentafluorophenyl)borate,
N,N-Dimethylaniliniumtetrakis(pentafluorophenyl)borate.

The Adduct T¹-T² has been described in WO 2004/089086. Preferably The Adduct T¹-T² has a solubility in ethanol of greater than or equal to 75 wt. %, more preferably between 75 and 90 wt. %.

Preferably the Adduct T¹-T² comprises from 75 to 96% by weight of T¹ and from 25% to 4% by weight of T². Preferably T1 is chosen from the group consisting of pyrethroids which are substantially stable up to a temperature of at least 150° C., and preferably substantially stable up to a temperature of at least 300° C., and mixtures thereof.

T2 is an ethylenically unsaturated substance and which is preferably substantially stable at a temperature of greater than or equal to 150° C. more preferably T² is substantially stable at a temperature of greater than or equal to 300° C.;

The adduct T¹-T² is formed by contacting T¹ and T² at a temperature equal to or greater than 80° C., preferably at a temperature from 80 to 150° C.

The pyrethroid substance T¹ has preferably formula (II)

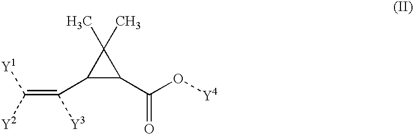

Wherein Y¹ Y² Y³ are hydrogen atoms or a hydrocarbon radical containing from 1 to 40 carbon atoms, optionally containing heteroatoms belonging to the groups 13-17 of the periodic table, or an halogen atom; and Y⁴ is a hydrocarbon radical containing from 1 to 40 carbon atoms, optionally containing heteroatoms belonging to the groups 13-17 of the periodic table, or an halogen atom;
T¹ is preferably chosen from the group consisting of (i) compounds of the allethrin, cinerin, jasmolin and pyrethrin family, (ii) compounds of the formula III:

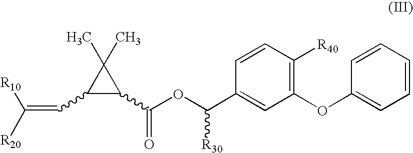

### Wherein

R¹⁰, and R²⁰, equal to or different from each other are selected from the group consisting of H, CH, OCH, SCH, CF, OCF, F, CI or Br;
R³⁰ is selected from the group consisting of H, CH, CN, CF, F, CI or Br;
R⁴⁰, is selected from the group consisting of H, CH, CF, OH, SH, F, CI or Br; and
the symbol [symbol] represents a bond having the R or S configuration; and (iii) mixtures thereof.

More preferably the pyrethroid substance T¹ is chosen from the group consisting of deltamethrin, cypermcthrin (more advantageously alpha-cypermethrin), cyhalothrin

(more advantageously h-cyhalothrin) and allethrin I

The ethylenically unsaturated substance T² is a surfactant (a) chosen preferably from amines and polyamines of the formulae IV and V, polyoxyalkylenated amines and polyamines of the formula VI and polyoxyalkylenated alkenylphenols of the formula VII:

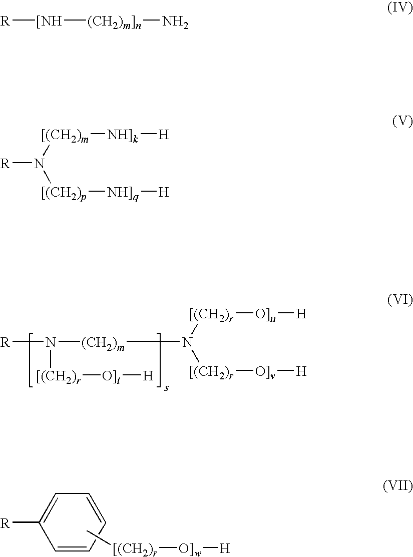

### Wherein:

R is a C₈-C₂₂, unsaturated aliphatic hydrocarbon radical having a linear (preferably) or branched chain,
k is an integer having a value of 1 to 8,
m is an integer having a value of 2 to 8,
n is an integer having a value of 0 to 8,
p is an integer having a value of 1 to 8,
q is an integer having a value of 1 to 8,
r is an integer having a value of 2 or 3,
s is an integer having a value of 0 to 8,
t is an integer having a value of 1 to 8,
u is an integer having a value of 0 to 8, and
v is an integer having a value of 0 to 8,
w is an integer having a value of 3 to 8.

The ethylenically unsaturated substance T² can also be a vinyl phosphate (b) having in its molecule the structure VIII:

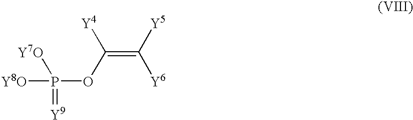

wherein
Y⁷ and Y⁸, equal to or different from each other are selected from C₁-C₄, alkyl group,
Y⁹ represents an oxygen atom or a sulphur atom, and
Y⁴, Y⁵ and Y⁶ are hydrogen atoms or a hydrocarbon radical containing from 1 to 40 carbon atoms, optionally containing heteroatoms belonging to the groups 13-17 of the periodic table, or an halogen atom; with the proviso that not more than two among Y⁴, Y⁵ and Y⁶ are hydrogen atoms, two group among Y⁴, Y⁵ and Y⁶ can also be joined to form an heterocyclic ring containing nitrogen, oxygen or sulphur atoms.

Preferably the vinyl phosphate (b) is dichlorvos, pirimiphos-methyl, chlorpyrifos, chlorfenvinphos and/or crotoxyphos.

The material of the present invention can be easily prepared by mixing component A) and component B), heating and extruding the resulting mixture. Optionally other substance normally used in the field of polymers such as antioxidant, stabilizer and so on can be mixed before the extrusion.

Preferably component B) can be first mixed with a small portion of component A) heated and extruded so that to obtain a masterbatch. Said masterbatch containing from 15 to 30% by weight of component B) can be further mixed with component A) in order to obtain the material of the present invention.

The material of the present invention can be used in form of sheets, films, filament or fiber. Thus a further object of the present invention is a sheet, a film, a filament or a fiber obtained by the material of the present invention.

Preferably the material of the present invention is used in form of filament or fibers to obtain for example non woven fabric. The material of the present invention is further particularly suitable for the production of mosquito nets. Thus a still further object of the present invention is a mosquito net comprising the material of the present invention.

With the material of the present invention it is possible to have a higher concentration of the insecticidal and acaricidal substance with respect to the polypropylene obtained by using a Ziegler-Natta catalyst system according to the test of the examples. This means that, when the propylene-based polymer (A) is used, the activity of the insecticidal has a wider range of action with respect to the other materials that can be used according to WO 2004/089086.

### EXAMPLES

The proton and carbon spectra of polymers were obtained using a Bruker DPX 400 spectrometer operating in the Fourier transform mode at 120° C. at 400.13 MHz and 100.61 MHz respectively. The samples were dissolved in C₂D₂Cl₄. As reference the residual peak of C₂DHCl₄ in the ¹H spectra (5.95 ppm) and the peak of the mmmm pentad in the ¹³C spectra (21.8 ppm) were used. Proton spectra were acquired with a 45° pulse and 5 seconds of delay between pulses; 256 transients were stored for each spectrum. The carbon spectra were acquired with a 90° pulse and 12 seconds of delay between pulses and CPD (waltz 16) to remove ¹H-¹³C couplings. About 3000 transients were stored for each spectrum.

### Polymer 1 (Comparative)

Polymer A is a commercial sample sold by Basell under the name Moplen HP561R obtained by using a Ziegler-Natta catalyst system (based on titanium and magnesium) having the following features:

MFR=25 (ISO 1133) g/10′

### Mw/Mn=3.3

Isotactic pentads mmmm=94.5%

### Polymer 2 (According to the Invention)

Polymer B is a commercial sample sold by Basell under the name Metocene HM562R obtained by using a metallocene catalyst system having the following features:

MFR=25 (ISO 1133) g/10′

### Mw/Mn=2.3

Isotactic pentads mmmm=92.5%

### Polymer 3 (According to the Invention)

Polymer C is a commercial sample sold by Basell under the name Metocene HM562S obtained by using a metallocene catalyst system having the following features:

MFR=30 ISO 1133) g/10′

### Mw/Mn=2.1

Isotactic pentads mmmm=92.5%

### Preparation of Insecticidal Component (B)

A mixture containing Deltamethrin (85 parts by weight) and dichlorvos (15 parts by weight) has been heated at 130° C. under stirring.

### Preparation of the Material

1 parts by weight of component B has been mixed with 99 parts by weight of polymers 1, 2 and 3 and the resulting compositions were pelletized in a twin screw extruder in order to obtain three samples marked respectively R1 R2 and R3.

### Preparation of Sheets

The resins R1, R2 and R3 were extruded in sheets of ca. 1.5 mm thickness, using the NMR/Kaufmann extrusion line to obtain respectively the sheets S1, S2 and S3

### Preparation of Fibers

The resins R1, R2 and R3 were spun in a Leonard pilot plant to prepare continuous fibers to obtain samples in form of fibers respectively F1, F2 and F3.

### Test of the Materials

Weighted samples of the materials S1, S2, S3, F1, F2 and F3 (all samples having the same weight) have been stored in different boxes provided with hole for air passage. Each box has been stored in a different room. In this way contamination among the various boxes has been avoided. Every week the concentration of the insecticide within each box has been measured by closing the hole and analyzing a sample of air of each box. The concentration of the sample S1 has been considered as 1 for each week and all the other have been calculated as a consequence. The results after 4 weeks are reported on table 1.

TABLE 1

| | S1* | S2 | S3 | F1* | F2 | F3 |
|---|---|---|---|---|---|---|
| Week 1 | 1 | 1.22 | 1.28 | 1.12 | 1.35 | 1.45 |
| Week 2 | 1 | 1.24 | 1.31 | 1.15 | 1.41 | 1.47 |
| Week 3 | 1 | 1.22 | 1.29 | 1.14 | 1.38 | 1.45 |
| Week 4 | 1 | 1.23 | 1.33 | 1.12 | 1.39 | 1.39 |

*comparative

Table 1 shows that, when the propylene polymer according to the invention is used, the concentration of the insecticide in the air is higher with respect to the use of a polymer obtained with a Ziegler-Natta catalyst. Consequently the use of the propylene polymer according to the invention results to be much more efficient.

1. A material having insecticidal and acaricidal properties comprising:
A) from 99.95 by weight to 70.0% by weight a propylene based polymer obtainable by using a catalyst system comprising a metallocene compound having the following properties:
i) a Melt Flow Rate (MFR) (ISO 1133) comprised between 2 and 100;
ii) A distribution of molecular weight Mw/Mn lower than 4;
iii) Isotactic pentads (mmmm) comprised between 90% and 99%;
B) from 0.05% to 30% by weight of an adduct of formula T¹-T² resulting from the condensation of T¹ and T², wherein
T¹ comprises at least one pyrethroid substance, which is substantially stable up to a temperature of at least 150° C.;
T² is an ethylenically unsaturated substance chosen from the group consisting of:
(a) a surfactant
(b) vinyl phospates and
(c) mixtures thereof.

2. The material according to claim 1 wherein from 99.5% to 85% by weight of A and 0.5% to 15% by weight of B is used.

3. The material according to claim 1 wherein in component A) the MFR is comprised between 6 and 60; the mmmm pentads are comprised between 91% and 95% and the distribution of molecular weight Mw/Mn is lower than 3.

4. A process for producing the material of claim 1 wherein components A) and B) are mixed, heated and extruded.

5. The process according to claim 4 wherein component from 15 to 30% by weight of component B) and 70% to 85% of component A) are mixed, with the mixture then being heated and extruded to form a masterbatch.

6. Sheets or films obtained from the material according to claim 1.

7. Filaments or fibers obtained from the material according to claim 1.

8. Non-woven materials obtained from the filaments or fibers according to claim 7.

9. A mosquito-net obtained by using the material of claim 1.

10. The material according to claim 2 wherein in component A) the MFR is comprised between 6 and 60; the mmmm pentads are comprised between 91% and 95% and the distribution of molecular weight Mw/Mn is lower than 3.

11. A process for producing the material of claim 2 wherein components A) and B) are mixed, heated and extruded.

12. A process for producing the material of claim 3 wherein components A) and B) are mixed, heated and extruded.

13. Sheets or films obtained from the material according to claim 2.

14. Sheets or films obtained from the material according to claim 3.

15. Filaments or fibers obtained from the material according to claim 2.

16. Filaments or fibers obtained from the material according to claim 3.

17. A mosquito-net obtained by using the material of claim 2.

18. A mosquito-net obtained by using the material of claim 3.
